(19) United States
(12) Patent Application Publication
(10) Pub. No.: US 2018/0157118 A1
(43) Pub. Date: Jun. 7, 2018

(54) LIGHT EMITTING PACKAGE, DISPLAY APPARATUS HAVING THE LIGHT EMITTING PACKAGE AND METHOD OF MANUFACTURING THE LIGHT EMITTING PACKAGE

(71) Applicant: Samsung Display Co., LTD., Yongin-si (KR)

(72) Inventors: HEE-KWANG SONG, Suwon-si (KR); YOUNGCHUN KIM, Hwaseong-si (KR); JUNGHYUN KIM, Suwon-si (KR)

(21) Appl. No.: 15/670,188

(22) Filed: Aug. 7, 2017

(30) Foreign Application Priority Data
Dec. 5, 2016 (KR) 10-2016-0164510

(51) Int. Cl. G02F 1/1335

(52) U.S. Cl. CPC G02F 1/133603

(57) ABSTRACT

A light emitting package includes a light source which generates light provided to a display panel which displays an image with the light; a lead frame on which the light source is disposed and to which power for driving the light source is applied; an encapsulation mold which covers an upper portion and a side portion of the light source to protect the light source; a reflector mold in which the light source, the lead frame and the encapsulation mold are disposed, the reflector mold including a reflection surface which reflects the light generated from the light source, by mirror surface reflection, and with the light source and the encapsulation mold disposed in the reflector mold, an air layer disposed between the reflection surface of the reflector mold and the encapsulation mold.

This application claims priority to Korean Patent Application No. 10-2016-0164510, filed on Dec. 5, 2016, and all the benefits accruing therefrom under 35 U.S.C. § 119, the content of which in its entirety is herein incorporated by reference.

### BACKGROUND

### 1. Field

Exemplary embodiments of the invention relate to an image display by a display apparatus, and more particularly to a light emitting package, a display apparatus including the light emitting package, and a method of manufacturing the light emitting package.

### 2. Description of the Related Art

A display apparatus such as a liquid crystal display apparatus includes a display panel and a backlight assembly.

The display panel displays an image. For example, when the display apparatus is the liquid crystal display apparatus, the display panel may include a first substrate including a thin film transistor and a pixel electrode, a second substrate facing the first substrate and including a color filter and a common electrode, and a liquid crystal layer interposed between the first substrate and the second substrate.

The backlight assembly includes a light source emitting light, and optical members for effectively transferring the light emitted from the light source to the display panel. In the prior art, a cold cathode fluorescent lamp (“CCFL”), an external electrode fluorescent lamp (“EEFL”), and the like are used. However, a light emitting diode (“LED”) having a relatively high luminance has been developed and is widely used.

When the LED is used as a light source, the LED is included in a light emitting package for protecting the LED and improving efficiency of light emitted from the LED.

### SUMMARY

One or more exemplary embodiment of the invention provides a light emitting package which increases efficiency of light provided within the display apparatus and decreases power consumption of a display apparatus.

One or more exemplary embodiment of the invention also provides a display apparatus including the above-mentioned light emitting package.

One or more exemplary embodiment of the invention also provides a method of manufacturing the above-mentioned light emitting package.

According to an exemplary embodiment of the invention, a light emitting package includes a light source which generates light provided to a display panel which displays an image with the light; a lead frame on which the light source is disposed and to which power for driving the light source is applied; an encapsulation mold which covers an upper portion and a side portion of the light source to protect the light source; a reflector mold in which the light source, the lead frame and the encapsulation mold are disposed, the reflector mold including a reflection surface which reflects the light generated from the light source, by mirror surface reflection, and with the light source and the encapsulation mold disposed in the reflector mold, an air layer disposed between the reflection surface of the reflector mold and the encapsulation mold.

In an exemplary embodiment, the reflection surface may include aluminum material.

In an exemplary embodiment, the air layer may be further disposed on an upper portion of the encapsulation mold.

In an exemplary embodiment, the lead frame and the reflection surface may form an obtuse angle.

In an exemplary embodiment, the light source may include a plurality of side portions. The reflector mold may be disposed facing each of the plurality of side portions of the light source, such reflector mold further disposed at a lower portion of the lead frame.

In an exemplary embodiment, the lead frame may pass through the reflector mold to be protruded from the reflector mold.

In an exemplary embodiment, the lead frame may be provided in plurality to include a first lead frame to which first power having a first polarity is applied, and a second lead frame to which second power having a second polarity different from the first polarity is applied. The second lead frame may be spaced apart from the first lead frame.

In an exemplary embodiment, the light source may be a blue light emitting diode which generates a blue light.

In an exemplary embodiment, the reflector mold and the encapsulation mold may be spaced apart from each other.

In an exemplary embodiment, the encapsulation mold may include silicon material.

According to an exemplary embodiment of the invention, a display apparatus includes a display panel and a light emitting package. The display panel generates an image with light. The light emitting package generates and provides the light to the display panel. The light emitting package includes a light source which generates the light, a lead frame on which the light source is disposed and to which power for driving the light source is applied, an encapsulation mold which covers an upper portion and a side portion of the light source to protect the light source, a reflector mold in which the light source, the lead frame and the encapsulation mold are disposed, the reflector mold including a reflection surface which reflects the light generated from the light source, by mirror surface reflection, and with the light source and the encapsulation mold disposed in the reflector mold, an air layer disposed between the reflection surface of the reflector mold and the encapsulation mold.

In an exemplary embodiment, the reflection surface may include aluminum material.

In an exemplary embodiment, the air layer may be further disposed on an upper portion of the encapsulation mold.

In an exemplary embodiment, the lead frame and the reflection surface may form an obtuse angle.

In an exemplary embodiment, the light source may include a plurality of side portions. The reflector mold may be disposed facing each of the plurality of side portions of the light source, such reflector mold further disposed at a lower portion of the lead frame.

In an exemplary embodiment, the lead frame may pass through the reflector mold to be protruded from the reflector mold.

In an exemplary embodiment, the reflector mold and the encapsulation mold may be spaced apart from each other.

In an exemplary embodiment, the display panel to which the light is provided from the light emitting package may include a first substrate including a first base substrate including a first sub pixel area, a second sub pixel area and a third sub pixel area, a thin film transistor on the first base substrate and a pixel electrode connected to a drain electrode of the thin film transistor, a second substrate including a second base substrate facing the first base substrate, a quantum dot layer including a red quantum dot layer in the first sub pixel area, a green quantum dot layer in the second sub pixel area and a transparent layer in the third sub pixel area and a common electrode formed on the quantum dot layer, and an optical medium layer interposed between the first substrate and the second substrate.

In an exemplary embodiment, the light source may be a blue light emitting diode generating a blue light.

According to an exemplary embodiment of the invention, a method of manufacturing a light emitting package includes disposing a light source which generates light, on a lead frame to which power for driving the light source is applied; providing a reflector mold including a reflection surface which reflects the light generated from the light source, by mirror surface reflection, on the lead frame having the light source thereon; with the reflector mold on the lead frame having the light source thereon, disposing an encapsulation mold covering an upper portion and a side portion of the light source to protect the light source, such encapsulation mold spaced apart from the reflector mold; and with the encapsulation mold covering the upper portion and the side portion of the light source, forming an air layer between the reflection surface of the reflector mold and the encapsulation mold.

According to one or more exemplary embodiment of the invention, since an air layer is formed between an encapsulation mold and a reflection surface of a reflector mold having a reflection effect the same as that of a mirror, a light efficiency of a light emitting package may be increased. Thus, power consumption of a display apparatus may be decreased.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is an exploded perspective view illustrating an exemplary embodiment of a display apparatus according to the invention;

FIG. 2 is a cross-sectional view of the display apparatus taken along line I-I′ of FIG. 1;

FIG. 3 is a perspective view illustrating an exemplary embodiment of a light emitting package of the display apparatus of FIG. 1;

FIG. 4 is a cross-sectional view of the light emitting package taken along line II-IF of FIG. 3;

FIGS. 5A to 5D are cross-sectional views illustrating an exemplary embodiment of a method of manufacturing the light emitting package of FIGS. 3 and 4; and

FIG. 6 is a cross-sectional view illustrating an exemplary embodiment of a display panel of the display apparatus of FIG. 1.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being related to another elements such as being “on” another element, it can be directly on the other element or intervening elements may be present therebetween. In contrast, when an element is referred to as being related to another element such as being “directly on” another element, there are no intervening elements present.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be explained in detail with reference to the accompanying drawings.

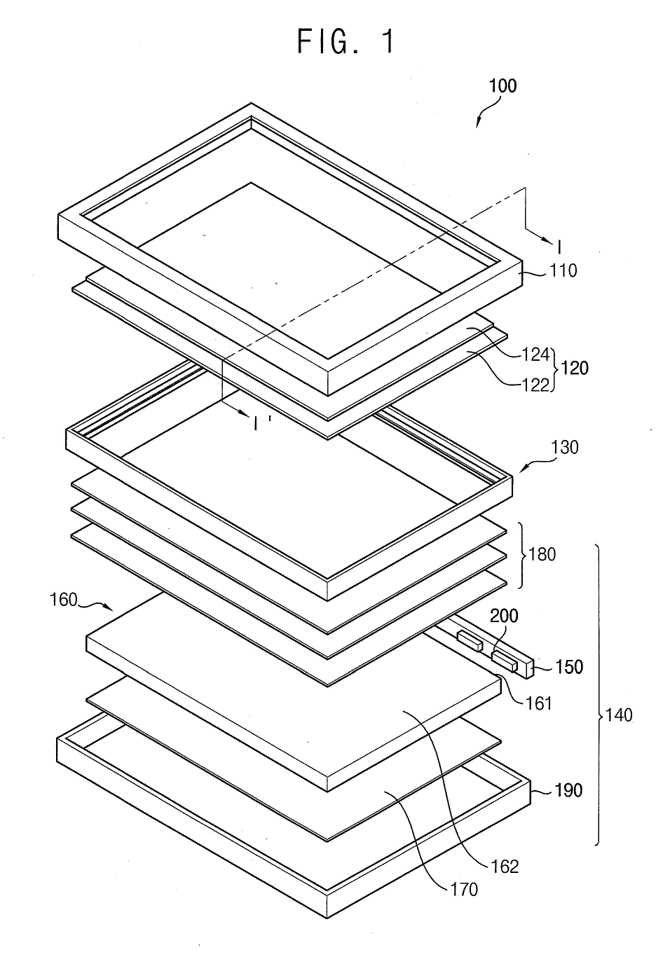

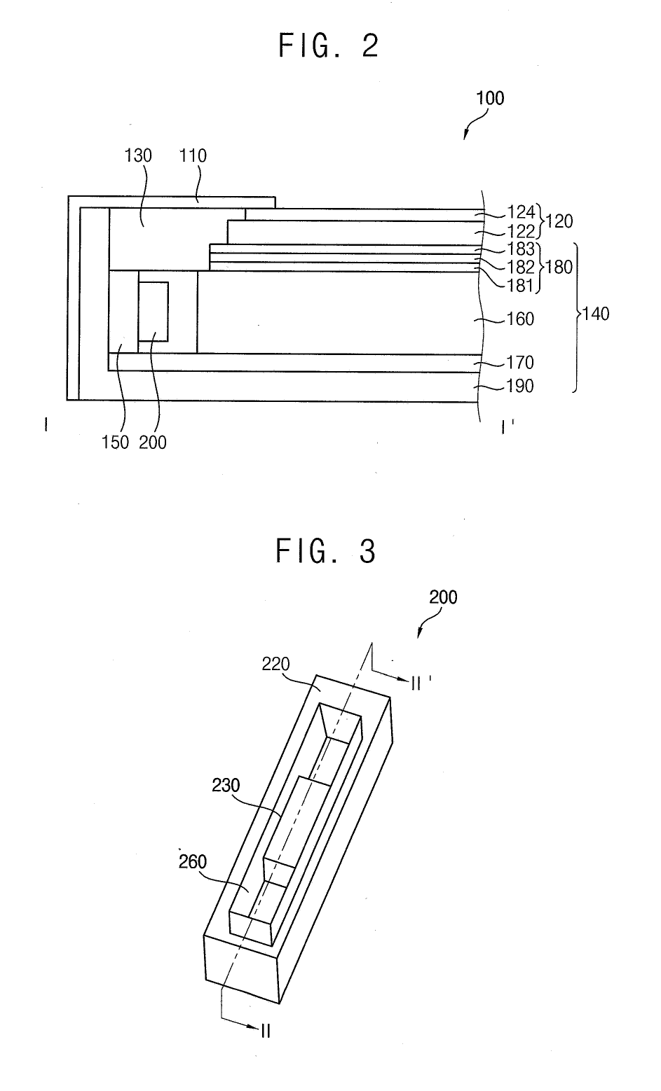

FIG. 1 is an exploded perspective view illustrating an exemplary embodiment of a display apparatus according to the invention. FIG. 2 is a cross-sectional view of the display apparatus taken along line I-I′ of FIG. 1.

Referring to FIGS. 1 and 2, the display apparatus 100 includes an upper receiving container 110, a display panel 120 and a backlight assembly 140. The display apparatus 100 and components thereof may have a relatively long side extended in a first direction, a relatively short side extended in a second direction crossing the first direction, and a thickness extended in a third direction crossing each of the first and second directions.

The upper receiving container 110 is disposed over the display panel 120 to protect the display panel 120 from an external impact thereto. A window is formed through or defined by the upper receiving container 110 to expose a display area of the display panel 120 at which an image is displayed.

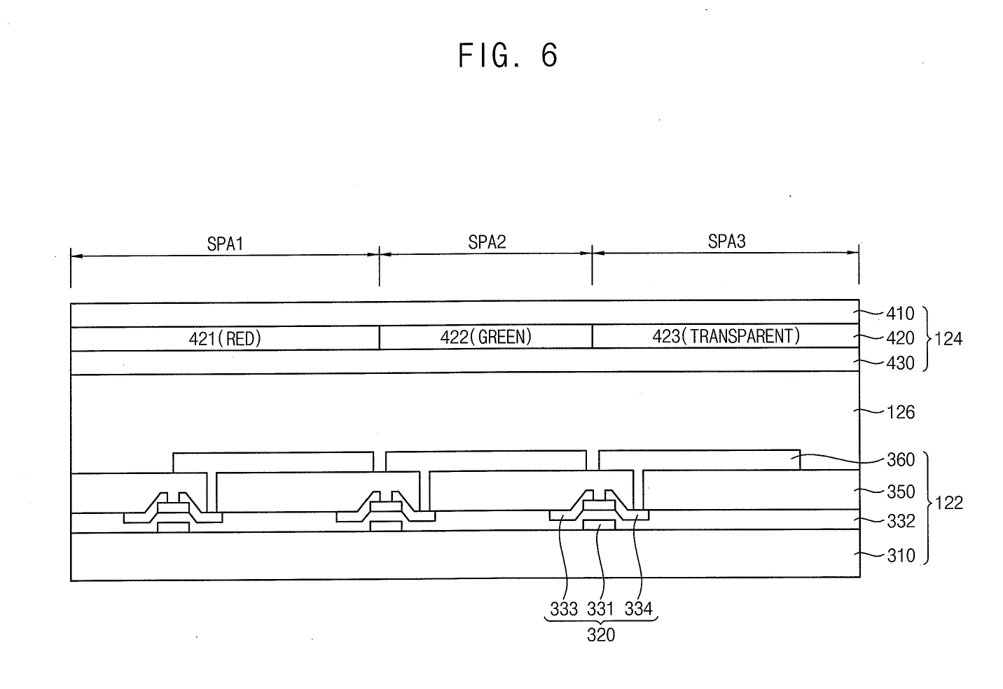

The display panel 120 displays the image using light provided from the backlight assembly 140. The display panel 120 is described later with reference to FIG. 6.

The backlight assembly 140 is disposed under the display panel 120 and provides the light to the display panel 120. The backlight assembly 140 includes a printed circuit board 150, a light emitting package 200, a light guide plate 160, a reflection sheet 170, optical sheets 180 and a lower receiving container 190.

Signal lines for supplying power to the light emitting package 200 are disposed or formed on the printed circuit board 150. The light emitting package 200 is disposed on the printed circuit board 150 and receives the power from the printed circuit board 150 to generate the light. In an exemplary embodiment, for example, the printed circuit board 150 may be a metal core printed circuit board (“MCPCB”) for transferring heat generated from the light emitting package 200. A plurality of the light emitting package 200 may be arranged along a length of the printed circuit board 150.

The light guide plate 160 is disposed at a side of the light emitting package 200. The light guide plate 160 includes a side surface 161 into which the light is incident to the light guide plate 160 and a light exiting surface 162 through which the light incident into the side surface 161 exits to the display panel 120. A plurality of the light emitting package 200 may be arranged along a length of the side surface 161 into which the light is incident.

The reflection sheet 170 is disposed between the light guide plate 160 and the lower receiving container 190, and between the light emitting package 200 and the lower receiving container 190, to reflect light leaking from the light emitting package 200 and from the light guide plate 160.

The optical sheets 180 are disposed over the light guide plate 160 to enhance an efficiency of the light exiting from the light guide plate 160. The optical sheets 180 may include a collection of individual sheets such as a first optical sheet 181, a second optical sheet 182 and a third optical sheet 183. In an exemplary embodiment, for example, respectively, the first optical sheet 181, the second optical sheet 182 and the third optical sheet 183 may be a diffusion sheet, a prism sheet and a light condensing sheet.

The lower receiving container 190 is combined with the upper receiving container 110 to receive the reflection sheet 170, the light guide plate 160, the printed circuit board 150, the light emitting package 200, the optical sheets 180 and the display panel 120 therein.

The display apparatus 100 may further include a mold frame 130. The mold frame 130 is disposed between the display panel 120 and the optical sheets 180 to support the display panel 120 thereon. The mold frame 130 fixes the light guide plate 160, the optical sheets 180 and the reflection sheet 170 to the lower receiving container 190.

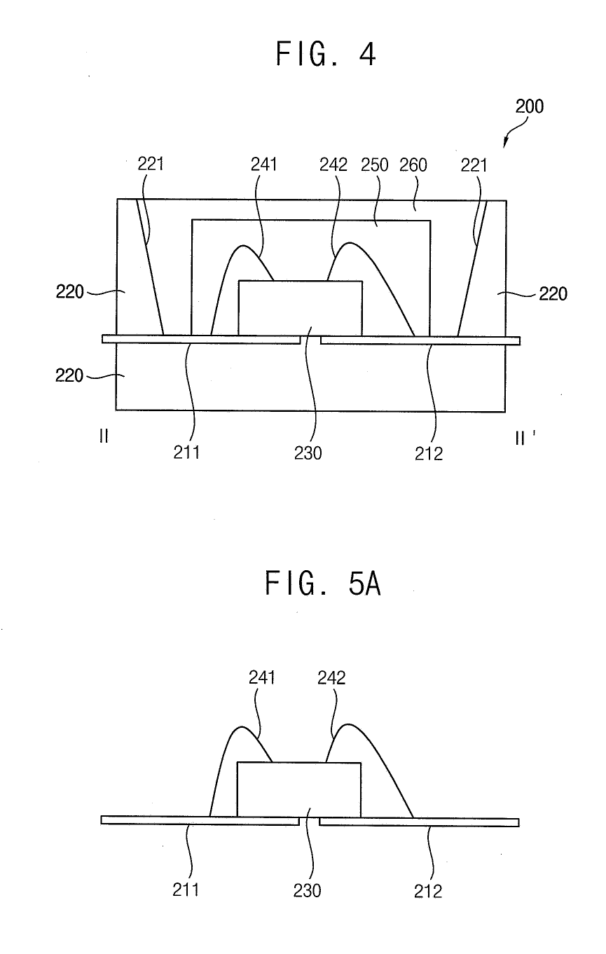

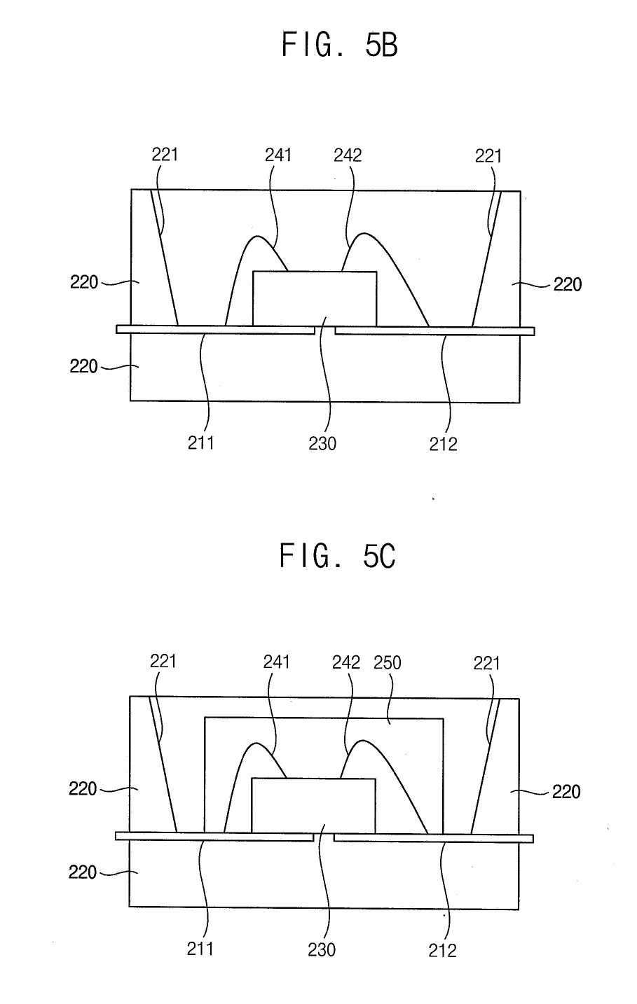

FIG. 3 is a perspective view illustrating an exemplary embodiment of the light emitting package 200 of FIG. 1. FIG. 4 is a cross-sectional view of the light emitting package 200 taken along line II-IF of FIG. 3.

Referring to FIGS. 1 to 4, the light emitting package 200 includes a first lead frame 211, a second lead frame 212, a reflector mold 220, a light source 230, a first wire 241, a second wire 242, an encapsulation mold 250 and an air layer 260. The light emitting package 200 may have a length dimension (horizontal in FIG. 4) which is relatively larger than a width dimension (into the view of FIG. 4), while having a thickness or height in a direction from the reflector mold 220 to the encapsulation mold 350 (vertical in FIG. 4). A lower surface of the light emitting package 200 may face the printed circuit board 150, while an upper surface thereof may face the light guide plate 160.

The first lead frame 211 and the second lead frame 212 are spaced from each other. Each of the first lead frame 211 and the second lead frame 212 passes through the reflector mold 220 and is electrically connected to the printed circuit board 150. FIG. 4 shows the first lead frame 211 and the second lead frame 212 disposed at an inner portion of the reflector mold 220 and extending to outside the light emitting package 200, to pass through the reflector mold 200. Each of the first lead frame 211 and the second lead frame 212 receives the power for driving the light source 230 from the printed circuit board 150. Specifically, power having a first polarity of the power the printed circuit board 150 is applied to the first lead frame 211, and power having a second polarity different from the first polarity of the power from the printed circuit board 150 is applied to the second lead frame 212. In an exemplary embodiment, for example, the first polarity may be a positive polarity and the second polarity may be a negative polarity. Alternatively, the first polarity may be a negative polarity and the second polarity may be a positive polarity.

The light source 230 is disposed on the first lead frame 211 and the second lead frame 212. A single light source 230 may be common to each of the first lead frame 211 and the second lead frame 212. The light source 230 may be a light emitting diode (“LED”). In an exemplary embodiment, for example, the light source 230 may be a blue light emitting diode which generates and emits a blue light. In this case, the light emitting package 200 may emit the blue light generated by the blue light emitting diode.

In the exemplary embodiment, the light source 230 is commonly disposed on each of the first lead frame 211 and the second lead frame 212, but is not limited thereto. In an exemplary embodiment, for example, the light source 230 may be disposed on only the first lead frame 211. Alternatively, the light source 230 may be disposed on only the second lead frame 212. The light source 230 may be mounted on the first lead frame 211 and the second lead frame 212.

The first wire 241 electrically connects the light source 230 with the first lead frame 211, and the second wire 242 electrically connects the light source 230 with the second lead frame 212.

The encapsulation mold 250 encapsulates the light source 230, the first wire 241 and the second wire 242 to protect the light source 230, the first wire 241 and the second wire 242. The encapsulation mold 250 may cover a side portion (vertical side in FIG. 4) and an upper portion (horizontal side in FIG. 4) of the light source 230. The encapsulation mold 250 may include silicon material. Referring to FIG. 3, each of the light source 230 and the encapsulation mold 250 may have a quadrangular shape, but the invention is not limited thereto. Where the encapsulation mold 250 covers the light source 230, the encapsulation mold 250 is disposed at all sides (e.g., each side) of the light source 230.

The reflector mold 220 is spaced apart from the encapsulation mold 250 and covers the light source 230. Where the light source 230 has a quadrangular shape, lateral portions or inner sidewalls of the reflector mold 220 are respectively disposed or formed at four side portions of the light source 230 in the top plan view. Where the reflector mold 220 covers the light source 230, the reflector mold 220 is disposed at all sides (e.g., each side) of the light source 230 and of the encapsulation mold 250. A portion of the reflector mold 220 may further be disposed or formed under the first lead frame 211 and the second lead frame 212.

The reflector mold 220 has a reflection surface 221 reflecting the light generated from the light source 230. The reflection surface 221 has a reflection effect the same as that of a mirror. In addition, the reflection surface 221 has a reflection characteristic the same as that of a mirror. For example, light rays follow a rather predictable pattern when it comes to reflection off a (plane) mirror surface. For a “mirror surface reflection,” the angle at which the light ray approaches the mirror surface is equal to the angle at which it departs from the mirror surface. Thus, the reflection surface 221 may reflect the light through a mirror surface reflection rather than a scattering reflection. In addition, the reflection surface 221 may include aluminum material.

The reflection surface 221 is inclined with respect to an extension direction of the first lead frame 211. Thus, the reflection surface 221 and the first lead frame 211 form an obtuse angle. In addition, the reflection surface 221 is inclined with respect to an extension direction of the second lead frame 212. Thus, the reflection surface 221 and the second lead frame 212 form an obtuse angle. The reflection surface 221 may define a sidewall of the reflector mold 220. The reflection surface 221 may define an opening in the reflector mold 220 in which the encapsulation mold 250 and the light source 230 are disposed. Where the encapsulation mold 250 is disposed at all sides of the light source 230, the reflection surface 221 sidewall may be disposed at all sides of the light source 230.

The air layer 260 is formed between the encapsulation mold 250 and the reflector mold 220. Specifically, the encapsulation mold 250 and the reflection surface 221 of the reflector mold 220 are spaced apart from each other to define a space between a lateral side of the encapsulation mold 250 and the reflection surface 221 of the reflector mold 220. Air is filled in the space between the lateral side of the encapsulation mold 250 and the reflection surface 221 of the reflector mold 220. The air layer 260 may further be formed on (e.g., above) the encapsulation mold 250 to be disposed above the encapsulation mold 250. That is, the air layer 260 may be disposed between the encapsulation mold 250 and an area external to the light emitting package 200, such that light emitted from the encapsulation mold 250 passes through the air layer 260 before being emitting outside the light emitting package 200.

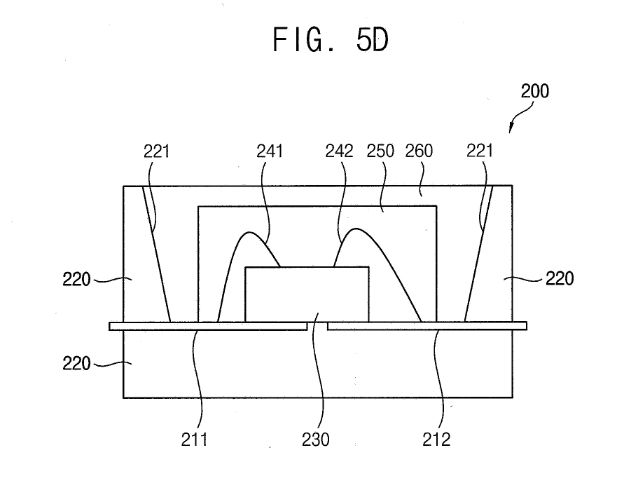

FIGS. 5A to 5D are cross-sectional views illustrating an exemplary embodiment of a method of manufacturing the light emitting package 200 of FIGS. 3 and 4.

Referring to FIGS. 3 to 5A, the light source 230 is disposed on the first lead frame 211 and/or the second lead frame 212. In addition, the first lead frame 211 is electrically connected to the light source 230 through the first wire 241, and the second lead frame 212 is electrically connected to the light source 230 through the second wire 242.

Referring to FIGS. 3 to 5B, the reflector mold 220 is formed on (e.g., above) the first lead frame 211 and the second lead frame 212. The reflector mold 220 has the reflection surface 221 having a height greater than that of the light source 230 so as to effectively cover the light source 230 to reflect the light generated from the light source 230. The reflection surface 221 has a reflection effect the same as that of a mirror. In addition, the reflection surface 221 has a reflection characteristic the same as that of a mirror. Thus, the reflection surface 221 may reflect the light through a mirror surface reflection rather than a scattering reflection. In addition, the reflection surface 221 may include aluminum material.

The reflector mold 220 may further be formed under the first lead frame 211 and the second lead frame 212. In this case, where portions of the reflector mold 220 are both above and below the first lead frame 211 and the second lead frame 212, the reflector mold 220 is formed such that the first lead frame 211 and the second lead frame 212 pass through the reflector mold 220 and are protruded from the reflector mold 220 to an outside thereof.

Referring to FIGS. 3 to 5C, the encapsulation mold 250 is formed. The encapsulation mold 250 is spaced apart from the reflector mold 220. The encapsulation mold 250 covers the upper portion and the side portion of the light source 230 to protect the light source 230. The encapsulation mold 250 may further cover the first wire 241 and the second wire 242 to further protect the first wire 241 and the second wire 242.

Referring to FIGS. 3 to 5D, the air layer 260 is formed between the reflector mold 220 and the encapsulation mold 250 at the space. Specifically, the encapsulation mold 250 and the reflection surface 221 of the reflector mold 220 are spaced apart from each other, and an air is filled in the space between the encapsulation mold 250 and the reflection surface 221 of the reflector mold 220. The air layer 260 may further be formed on the encapsulation mold 250 to be disposed above the encapsulation mold 250. In an exemplary embodiment, the disposing of the encapsulation mold 250 covering the upper portion and the side portion of the light source 230 in the reflector mold 220, forms the air layer 260 between the reflection surface 221 of the reflector mold 220 and the encapsulation mold 250.

[Table 1] shows a reflectivity in percent (%), optical power in watt (W) and a light emission rate in percent (%) according to a comparison example, and a reflectivity, optical power and a light emission rate according to the present exemplary embodiment, for describing an effect of the invention.

TABLE 1

| Comparison | | | | |
|---|---|---|---|---|
| example/ | | | | |
| Present | | | Optical | Light |
| exemplary | | Reflectivity | power | emitting |
| embodiment | Reflection | (%) | (W) | rate (%) |
| Comparison | Mirror (mirror | 100 | 0.332 | 106 |
| example | surface) | 95 | 0.297 | 95 |
| | reflection | 90 | 0.274 | 88 |
| | Scattering | 100 | 0.362 | 116 |
| | reflection | 95 | 0.313 | 100 |
| | | 90 | 0.277 | 89 |
| Present | Mirror (mirror | 100 | 0.338 | 108 |
| exemplary | surface) | 95 | 0.325 | 104 |
| embodiment | reflection | 90 | 0.312 | 100 |
| | Scattering | 100 | 0.317 | 101 |
| | reflection | 95 | 0.301 | 96 |
| | | 90 | 0.287 | 92 |

In [Table 1], the comparison example is an embodiment in which the encapsulation mold 250 is formed in an area of the air layer 260 but the air layer 260 is omitted in the light emitting package 200. The reflectivity refers to a rate of light reflected from the reflector mold 220 compared to the light generated from the light source 230. The optical power refers to power of light emitted from the light emitting package 200, and a unit of the optical power is Watt. The light emitting rate refers to a rate of the light emitted from the light emitting package 200 compared to the light generated from the light source 230.

Referring to [Table 1], in the comparison example, in the case in which the reflection of the reflector mold 220 is the mirror surface reflection, when the reflectivity is about 100%, the optical power is about 0.332 Watt and the light emitting rate is about 106%. In contrast, in the present exemplary embodiment, in the case in which the reflection of the reflector mold 220 is the mirror surface reflection, when the reflectivity is about 100%, the optical power is about 0.338 Watt and the light emitting rate is about 108%.

In addition, in the comparison example, in the case in which the reflection of the reflector mold 220 is the mirror surface reflection, when the reflectivity is about 95%, the optical power is about 0.297 Watt and the light emitting rate is about 95%. In contrast, in the present exemplary embodiment, in the case in which the reflection of the reflector mold 220 is the mirror surface reflection, when the reflectivity is about 95%, the optical power is about 0.325 Watt and the light emitting rate is about 104%.

In addition, in the comparison example, in the case in which the reflection of the reflector mold 220 is the mirror surface reflection, when the reflectivity is about 90%, the optical power is about 0.274 Watt and the light emitting rate is about 88%. In contrast, in the present exemplary embodiment, in the case in which the reflection of the reflector mold 220 is the mirror surface reflection, when the reflectivity is about 90%, the optical power is about 0.312 Watt and the light emitting rate is about 100%.

Therefore, the optical power of the present exemplary embodiment is higher than the optical power of the comparison example, and the light emitting rate of the present exemplary embodiment is higher than the light emitting rate of the comparison example. Thus, when the air layer 260 is formed between the encapsulation mold 250 and the reflection surface 221 of the reflector mold 250, and between an area external to the light emitting package 200 and each of the encapsulation mold 250 and the reflection surface 221, a light efficiency of the light emitting package 200 may be improved.

FIG. 6 is a cross-sectional view illustrating an exemplary embodiment of the display panel 120 of FIG. 1.

Referring to FIGS. 1 and 6, the display panel includes a first (display) substrate 122, a second (display) substrate 124 and an optical medium layer such as a liquid crystal layer 126. The display panel 120 may include a quantum dot, and the display panel 120 may be a photo luminescence display panel, but the invention is not limited thereto.

The first substrate 122 includes a first base substrate 310, a thin film transistor 320, a gate insulating layer 332, an organic insulating layer 350 and a pixel electrode 360. The thin film transistor 320 and the pixel electrode 360 may be provided in plurality, such as being disposed in the display area of the display panel 120.

The first base substrate 310 includes a first sub pixel area SPA1 in which a first sub pixel is formed, a second sub pixel area SPA2 in which a second sub pixel is formed, and a third sub pixel area SPA3 in which a third sub pixel is disposed or formed. The first base substrate 310 may be a glass substrate. Alternatively, the first base substrate 310 may be a plastic substrate.

The thin film transistor 320 is disposed or formed in each of the first sub pixel area SPA1, the second sub pixel area SPA2 and the third sub pixel area SPA3. The thin film transistor 320 is disposed or formed on a front surface of the first base substrate 310, and includes a gate electrode 331, the gate insulating layer 332 covering the gate electrode 331, a source electrode 333, and a drain electrode 334 spaced apart from the source electrode 333.

The organic insulating layer 350 covers the thin film transistor 320 and is common to each of the sub pixel areas.

The pixel electrode 360 is disposed or formed on the organic insulating layer 350. The pixel electrode 260 is electrically connected to the drain electrode 334 of the thin film transistor 320 at and through a contact hole formed through the organic insulating layer 350.

The second substrate 124 includes a second base substrate 410, a quantum dot layer 420 and a common electrode 430.

The second base substrate 410 faces the first base substrate 310. The second base substrate 410 may be a glass substrate. Alternatively, the second base substrate 410 may be a plastic substrate.

The quantum dot layer 420 includes a red quantum dot layer (portion) 421, a green quantum dot layer (portion) 422 and a transparent layer (portion) 423. The red quantum dot layer 421 is disposed or formed in the first sub pixel area SPA1. The green quantum dot layer 422 is disposed or formed in the second sub pixel area SPA2. The transparent layer 423 is disposed or formed in the third sub pixel area SPA3. When the light emitting package 200 emits the blue light, the blue light excites or is converted by the red quantum dot layer 421 and thus a red color light is displayed in the first sub pixel area SPA1. In addition, the blue light excites or is converted by the green quantum dot layer 422 and thus a green color light is displayed in the second sub pixel area SPA2. In addition, the blue light is transmitted in the transparent layer 423 without exciting the transparent layer 423 or being converted to another color light, and thus a blue is displayed in the third sub pixel area SPA3.

The common electrode 430 is disposed on the quantum dot layer 420.

The liquid crystal layer 126 is interposed between the first substrate 122 and the second substrate 124. The liquid crystal layer 126 includes a liquid crystal of which an arrangement is changed by an electric field formed between the pixel electrode 360 of the first substrate 122 and the common electrode 430 of the second substrate 124.

According to one or more exemplary embodiment, since the air layer 260 is formed between the encapsulation mold 250 and the reflection surface 221 of the reflector mold 220 having a reflection effect the same as that of a mirror, the light efficiency of the light emitting package 200 may be increased. Thus, power consumption of the display apparatus 100 may be decreased.

The above-described exemplary embodiments and features thereof may be applied to an electronic device having a display apparatus or which display an image. For example, one or more exemplary embodiment according to the invention may be applied to a television, a computer monitor, a laptop, a digital camera, a cellular phone, a smart phone, a tablet personal computer (“PC”), a smart pad, a personal digital assistant (“PDA”), a portable multimedia player (“PMP”), an MP3 player, a navigation system, a camcorder, a portable game console, etc.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A light emitting package comprising:
a light source which generates light provided to a display panel which displays an image with the light;
a lead frame on which the light source is disposed and to which power for driving the light source is applied;
an encapsulation mold which covers an upper portion and a side portion of the light source to protect the light source;
a reflector mold in which the light source, the lead frame and the encapsulation mold are disposed, the reflector mold comprising a reflection surface which reflects the light generated from the light source, by mirror surface reflection, and
with the light source and the encapsulation mold disposed in the reflector mold, an air layer disposed between the reflection surface of the reflector mold and the encapsulation mold.

2. The light emitting package of claim 1, wherein the reflection surface includes aluminum material.

3. The light emitting package of claim 1, wherein with the light source and the encapsulation mold disposed in the reflector mold, the air layer is further disposed on an upper portion of the encapsulation mold.

4. The light emitting package of claim 1, wherein with the lead frame disposed in the reflector mold, the lead frame and the reflection surface of the reflector mold form an obtuse angle.

5. The light emitting package of claim 1, wherein
the light source comprises a plurality of side portions, and
the reflector mold is disposed facing each of the plurality of side portions of the light source, such reflector mold further disposed at a lower portion of the lead frame.

6. The light emitting package of claim 5, wherein with the reflector mold disposed at the lower portion of the lead frame, the lead frame passes through the reflector mold to be protruded from the reflector mold.

7. The light emitting package of claim 1, wherein the lead frame is provided in plurality and comprises:
a first lead frame to which first power having a first polarity is applied; and
a second lead frame to which second power having a second polarity different from the first polarity is applied,
wherein the second lead frame is spaced apart from the first lead frame.

8. The light emitting package of claim 1, wherein the light source is a blue light emitting diode which generates a blue light.

9. The light emitting package of claim 1, wherein the reflector mold and the encapsulation mold are spaced apart from each other.

10. The light emitting package of claim 1, wherein the encapsulation mold includes silicon material.

11. A display apparatus comprising:
a display panel which displays an image with light; and
a light emitting package which generates and provides the light to the display panel,
wherein the light emitting package comprises:
a light source which generates the light,
a lead frame on which the light source is disposed and to which power for driving the light source is applied,
an encapsulation mold which covers an upper portion and a side portion of the light source to protect the light source,
a reflector mold in which the light source, the lead frame and the encapsulation mold are disposed, the reflector mold comprising a reflection surface which reflects the light generated from the light source, by mirror surface reflection, and
with the light source and the encapsulation mold disposed in the reflector mold, an air layer disposed between the reflection surface of the reflector mold and the encapsulation mold.

12. The display apparatus of claim 11, wherein the reflection surface includes aluminum material.

13. The display apparatus of claim 11, wherein with the light source and the encapsulation mold disposed in the reflector mold, the air layer is further disposed on an upper portion of the encapsulation mold.

14. The display apparatus of claim 11, wherein with the lead frame disposed in the reflector mold, the lead frame and the reflection surface form an obtuse angle.

15. The display apparatus of claim 11, wherein
the light source comprises a plurality of side portions, and
the reflector mold is disposed facing each of the plurality of side portions of the light source, such reflector mold further disposed at a lower portion of the lead frame.

16. The display apparatus of claim 15, wherein with the reflector mold disposed at the lower portion of the lead frame, the lead frame passes through the reflector mold to be protruded from the reflector mold.

17. The display apparatus of claim 11, wherein the reflector mold and the encapsulation mold are spaced apart from each other.

18. The display apparatus of claim 11, wherein the display panel to which the light is provided from the light emitting package comprises:
a first substrate comprising: a first base substrate including a first sub pixel area, a second sub pixel area and a third sub pixel area, a thin film transistor on the first base substrate, and a pixel electrode connected to a drain electrode of the thin film transistor;
a second substrate comprising: a second base substrate facing the first base substrate, a quantum dot layer comprising a red quantum dot layer in the first sub pixel area, a green quantum dot layer in the second sub pixel area and a transparent layer in the third sub pixel area, and a common electrode on the quantum dot layer; and
an optical medium layer interposed between the first substrate and the second substrate.

19. The display apparatus of claim 18, wherein the light source is a blue light emitting diode generating a blue light.

20. A method of manufacturing a light emitting package, the method comprising:
disposing a light source which generates light, on a lead frame to which power for driving the light source is applied;
providing a reflector mold comprising a reflection surface which reflects the light generated from the light source, by mirror surface reflection, on the lead frame having the light source thereon;
with the reflector mold on the lead frame having the light source thereon, disposing an encapsulation mold covering an upper portion and a side portion of the light source to protect the light source, such encapsulation mold spaced apart from the reflector mold; and
with the encapsulation mold covering the upper portion and the side portion of the light source, forming an air layer between the reflection surface of the reflector mold and the encapsulation mold.
